(19) United States
(12) Patent Application Publication
(10) Pub. No.: US 2006/0049639 A1
(43) Pub. Date: Mar. 9, 2006

(54) Motor vehicle door

(76) Inventors: Johannes-Theodor Menke, Velbert (DE); Ulrich Nass, Mulheim (DE); Gerhard Zimmerman, Velbert (DE); Carsten Baumchen, Oberthal (DE); Michael Herrmann, Neukirchen-Vlyn (DE); Andreas Kasper, Oberhausen (DE); Stefan Armbruster, Heiligenhaus (DE); Jorg Axmann, Ratingen (DE); Christian Johiel, Heiligenhaus (DE); Jurgen Kill, Koln (DE); Thomas Schonenberg, Burscheid (DE)

Correspondence Address: MATTHIAS SCHOLL, 14781 MEMORIAL DRIVE, SUITE 1319, HOUSTON, TX, 77079, US

(21) Appl. No.: 10/536,830

(22) PCT Filed: Dec. 1, 2003
(86) PCT No.: PCT/DE03/03973

§ 371 Date: Jun. 13, 2005

(30) Foreign Application Priority Data
Dec. 3, 2002 (DE) 102 56 266.0

(51) Int. Cl. B60J 5/00

(52) U.S. Cl. 292/1; 296/146.1

(57) ABSTRACT

The object of the present invention is a vehicle door including a vehicle door latch (1) with a housing (2, 3) and with at least one additional assembly (4) According to the invention, the additional assembly (4) is connected to the housing (2, 3) of the vehicle door latch (1).

### CROSS-REFERENCE TO RELATED APPLICATIONS

This is a National Stage Application of international Patent Application No. PCT/DE 2003/003973, with an international filing date of Dec. 1, 2003, which is based on German Patent Application No. 102 56 266.0, filed Dec. 3, 2002. The contents of both of these specifications are incorporated herein by reference.

### BACKGROUND OF THE INVENTION

1. Field of the Invention

The invention refers to a vehicle door comprising a vehicle door latch with a housing and at least one additional assembly.

2. Description of Related Art

A vehicle door of the above design is, for instance, disclosed by DE 100 57 352 A1. The additional assembly is in this case a drive for a window lifting mechanism. Said drive, the door latch and the window lifting mechanism are fixed to the same supporting member. Said supporting member is a latch mounting plate.

In principle, this known procedure already successfully intends to make the best possible use of the door interior, generally covered by the door coverings. As it is this space that not only increasingly often houses additional assemblies, such as the described window lifting device but also side airbag systems, speaker arrangements, height adjustment devices for the arm rest, lights indicating open vehicle doors, control elements for the door mirrors as well as the door latch and mirror heating system.

All said assemblies must thus be accommodated in the existing (constricted) area. This applies even more so, if the door interior is to be used for even more purposes, such as, for instance, a storage space for traveling provisions (bottles, tins or similar packaging).

In the past, attempts were already made to combine this collection of additional assembly inside the vehicle door by using assembly carriers or so-called door module carrying panels. Although they allow a simplified preassembly of the individual additional assemblies, they are usually made of metal and thus cause a not inconsiderable increase in weight. They also have a projecting design (see DE 197 47 709 A1).

Due to the increasing number of available models, a wide variety of different door module carrying panels are also required, making the design, storage and assembly more difficult. Also, the emphasis is generally on reducing and not increasing the weight of vehicles. The invention intends, in any case, to resolve these problems.

### BRIEF SUMMARY OF THE INVENTION

The invention described herein provides a vehicle door including a vehicle door latch (1) with a housing (2, 3) and with at least one additional assembly (4) characterized in that the additional assembly (4) is connected to the housing (2, 3) of the vehicle door latch (1).

In certain embodiments of the present invention, the housing (2, 3) comprises a latch case (2) and a latch housing (3a) and a latch cover (3b), with the latch housing (3a) and latch cover (3b) consisting of one or two parts.

In certain embodiments of the present invention, the additional assembly (4) is arranged on the external surface of the latch cover (3b) of the housing (2, 3).

In certain embodiments of the present invention, the additional assembly (4) is secured in a seat (10) of the housing (2, 3).

In certain embodiments of the present invention, a common control unit (12) is provided for controlling the vehicle door latch (1) and the additional assembly (4).

In certain embodiments of the present invention, the additional assembly (4) and the door latch (1) are connected to a corresponding control board (11).

In certain embodiments of the present invention, the additional assembly (4) apart from its original tasks, such as lifting windows, adjusting mirrors, etc. also carries out latch functions, such as i.e. electric opening, closing, double locking/unlocking, engaging disengaging child lock, central locking, etc. at the same or at different times.

In certain embodiments of the present invention, the latch case (2) comprises an axial support (20) for the latch housing (3a).

In certain embodiments of the present invention, the latch cover (3b) contains at least one rib (21) for reinforcement.

### BRIEF DESCRIPTION OF THE DRAWINGS

Below, the invention is described in more detail with reference to drawings representing only one embodiment, in which:

FIG. 1 represents a diagrammatic view of an operating and/or closing device with a vehicle door latch and a window-lifting device, constituting components of a vehicle door.

FIG. 2 shows the object of FIG. 1, reduced to the assembly consisting of the vehicle door latch and the drive for the window-lifting device with a modified design.

FIG. 3 shows an exploded view of the drive for the window lifting device according to FIG. 1 or 2, connected to a control board of the vehicle door latch.

FIG. 4 shows a vehicle door combined with the installed assemblies acc. to FIG. 1.

FIG. 5 represents a section of FIG. 2 along line A-A.

### DETAILED DESCRIPTION OF THE INVENTION

The invention is based on the technical problem of further developing a vehicle door of the above design in such a way that a simpler design achieves a reduction in weight and optimum utilization of the space inside the door.

In order to solve this technical problem, the invention provides a vehicle door of the said type, characterized in that the additional assembly is connected to the housing of the vehicle door latch. In contrast to DE 100 57 352 A1 no additional latch-carrying panel is thus used but instead, the housing of the vehicle door latch assumes the described function.

The vehicle door latch can be of any possible design, e.g. like the one described in DE 297 23 462 U1. As usual, the latch will contain a locking mechanism consisting of a rotary latch and a pawl, at least one operating lever and a locking lever, being a central locking lever. This is, however, not mandatory.

In the vehicle door latch according to DE 297 23 462 U1, a latch plate accommodates the locking mechanism consisting of a rotary latch and a pawl. The latch plate is also referred to as latch case or closing element shell. Next to the latch plate is the so-called latch housing as well as a latch cover, covering the latch housing. The latch plate is made of metal, whilst the latch housing and the latch cover are made of plastic.

The door latch is generally connected, i.e. bolted to the lateral front wall of a vehicle door via the latch plate. The latch cover is generally arranged opposite the latch plate facing the door interior.

In the context of the present invention, housing refers to the covering or casing surrounding the latch mechanism. The housing can consist of one, two or three parts. In case of a two-part design, the latch cover is part of the latch housing and located next to the latch plate or the latch case. This housing can be designed as being fully enclosed, as described in DE 199 20 278 A1 or can contain small or larger openings.

According to the invention, the additional assembly can be preferably attached on the surface of the latch housing facing towards the outside and, in case of a single-part embodiment of the cover from latch housing and latch cover, on the housing surface facing the latch plate. In case of a two-part housing design, this surface is formed by the separate latch cover, accommodating the additional assembly in this case. The latch cover has thus at least a dual function, sealing the overall vehicle door latch as well as serving as a holder or seat for one or several additional assemblies. The additional assembly can be fixed to a seat of the housing or latch cover with usual means of fixing, such as bolting, riveting or clipping being possible and being used.

Preferably, the latch housing and latch cover are made from plastic, with thermoplastic plastic having found to be particularly suitable. In this context, the use of polybutylenterphthalate plastic (PBT) is particularly preferred and, depending on the weight and volume of the additional assembly to be connected, contains a fiberglass content of up to 30 volume percent, providing a respective reinforcement.

It has also been found to be beneficial to equip the latch housing and thus the latch cover with an additional axial support, if it is used as an assembly carrier. Said support generally consists of a metal bracket connected to the latch panel or latch case, also made of metal. Furthermore, the latch cover can contain at least one rib for further stiffening, as explained in more detail with reference to the figure description.

An operating and/or closing device does not only work with the described vehicle door latch but can, for instance, also include a support bow for accommodating the external and/or internal door handle, as described in EP 0 400 505 B1. In this case, the respective door handle, the support bow and the door latch form a compact installation module, also referred to as latch module. As part of the invention, the additional assembly/assemblies is/are again connected to the housing of this installation module.

In this case, the housing can, apart from accommodating the vehicle door latch as such, also serve as a connection to the external door handle, as described in EP 0 400 505 B1. In other words, the described connection of the additional assembly to the housing naturally also contains types in which a compact installation module, consisting of an operating and/or closing device including vehicle door latch and internal/external door handle, is equipped with a continuous housing, in turn accommodating the described additional assembly as a support.

In order to simplify the design even further, it has been found to be beneficial to provide a common control unit for controlling the vehicle door latch and the additional assembly. The same concept also includes measures for connecting the additional assembly and the door latch to a corresponding control board. As a result, representation of the wiring is particularly easy.

The additional assembly can be a triggering mechanism for a side airbag or all side airbags, a loudspeaker arrangement, a height adjustment for the arm rest, a light for indicating an open vehicle door, a control unit for the door latch, a mirror heating/adjusting device, etc. Preferably, the vehicle door latch and the window lifting mechanism are combined as additional assembly.

Of special significance is, however, that the additional assembly, apart from its original tasks, such as lifting windows, adjusting mirrors, etc. also carries out latch functions, such as i.e. electric opening, closing, double locking/unlocking, engaging/disengaging child lock, central locking, etc. at the same or at different times. This means that the additional assembly or at least one drive motor of the additional assembly carries out two or several functions. It is, for instance, feasible that the drive of a window lifting mechanism not only produces the desired window position but also activates the connected door latch by electrically opening it. This refers to the motorized rotation of the pawl as described, for instance, in DE 195 30 723 A1. Alternatively or in addition, said drive can also be used to provide a closing function as, for instance, the object of DE 199 42 360 A1. Potential additional functions also include activation of double locking and/or child lock and their deactivation. Naturally it is also possible to use the drive for the window lifting device and/or the window lifting motor for the central locking of the vehicle door latch.

The figures show a vehicle door with an operating and/or closing device. The principle design of the vehicle door includes a vehicle door latch 1 with housing 2, 3 and an additional assembly 4 connected to the housing 2, 3. In the embodiment, the additional assembly 4 drives a window lifting mechanism 5. Consequently, additional assembly 4 and window lifting mechanisms 5 constitute a window-lifting device 4, 5 in the representation.

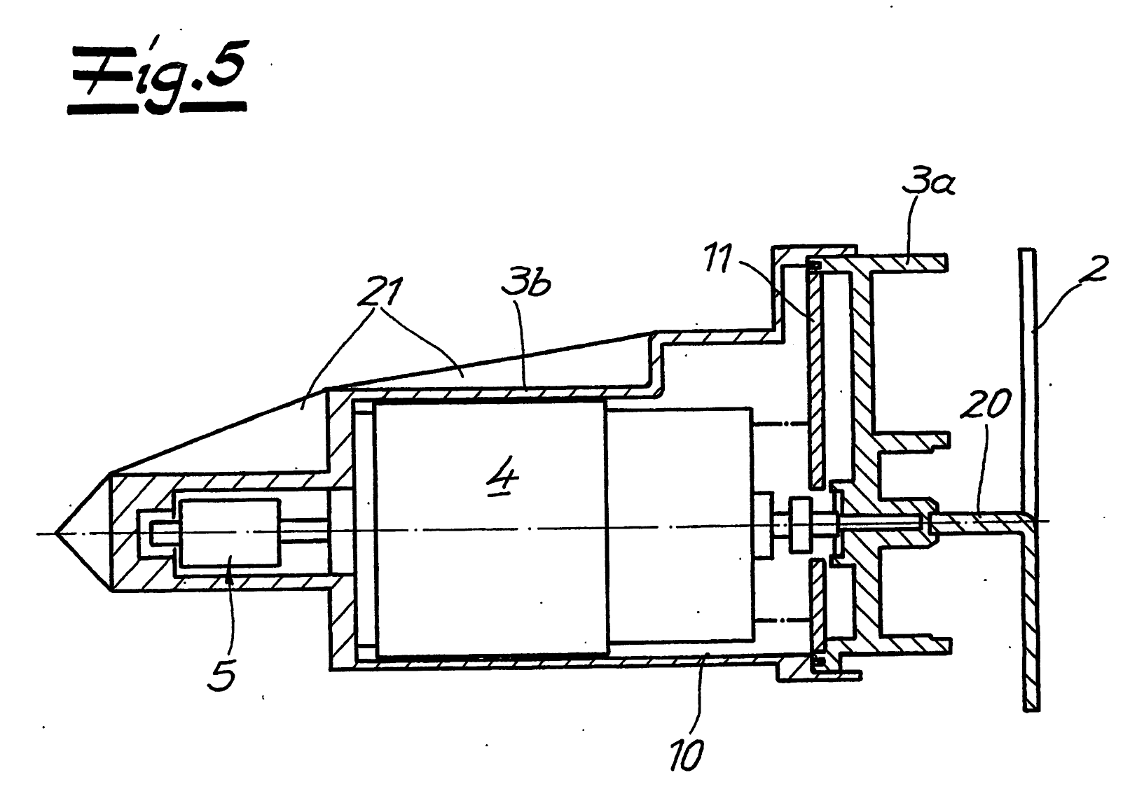

FIG. 5, in particular, shows that housing 2, 3 and/or the covering enclosing the entire latch mechanism, generally comprises a latch plate and/or a latch case 2 as well as a two-part cover 3 and/or 3a, 3b. Cover 3 or 3a, 3b actually consists of latch housing 3a and latch cover 3b. Latch housing 3a is closed off by latch cover 3b. Latch housing 3a and latch cover 3b can also form a single component or a single-part cover 3.

The latch case or the latch plate 2 allows fixing of the door latch on, for instance, the lateral end wall of the vehicle door. In contrast, the latch cover 3b extends—opposite to the latch plate 2—towards the door interior. Latch housing 3a and latch cover 3b are made of plastic, whilst the latch case or the latch plate 2 is made of sheet metal. The same also applies for an axial support 20, referring in the context of this embodiment to a vertical ridge and/or bracket 20 upstanding in relation to latch case 2. This vertical ridge or bracket 20 or the axial support 20 ensures that the latch housing 3a is stabilized in accordance with the representation in FIG. 5. This naturally also applies in the same way for latch cover 3b connected to latch housing 3a.

The axial support 20 together with ribs 21 on the latch cover 3b ensure together that the latch cover 3b has the stability required for not only fulfilling its original sealing function but to also function as an additional assembly carrier. This is explained in more detail below. The same concept includes measures to at least produce the latch cover 3b (generally also latch housing 3a) from glass fiber reinforced plastic.

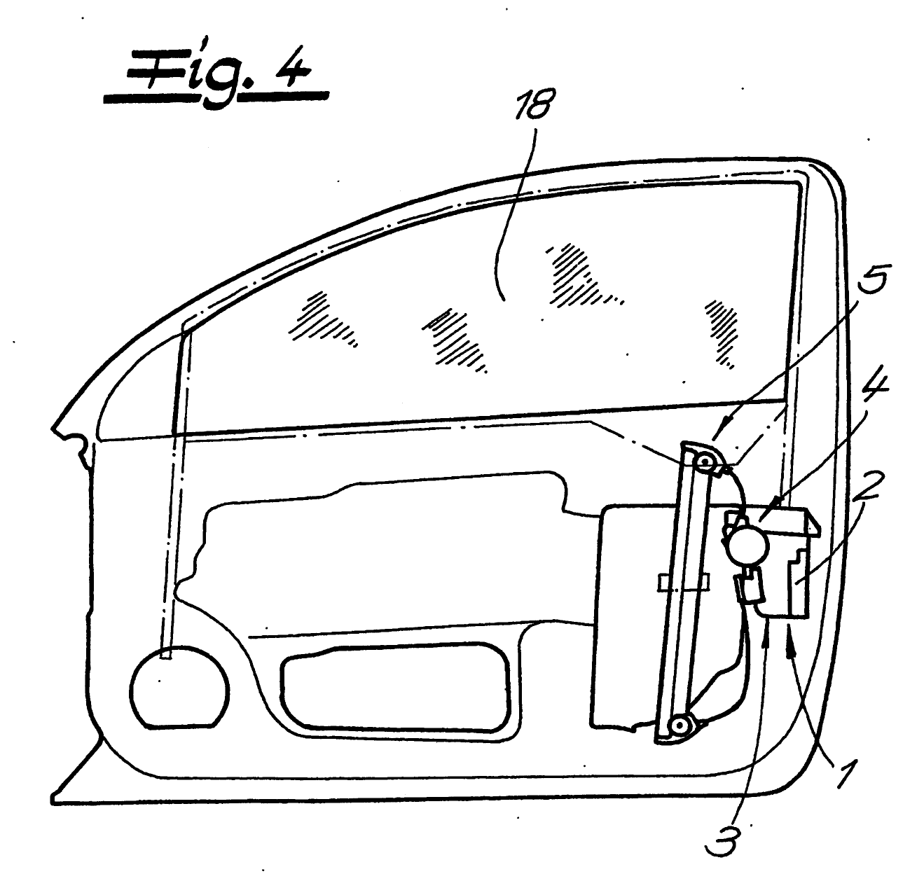

In the embodiment, the additional assembly 4 is connected to the housing 2, 3 of the vehicle door latch 1. As part of the invention, the window lifting mechanism 5 can naturally also be fixed to the housing 2, 3, which is, however, not shown. The installation situation of the above individual parts 1 to 5 is apparent from FIG. 4.

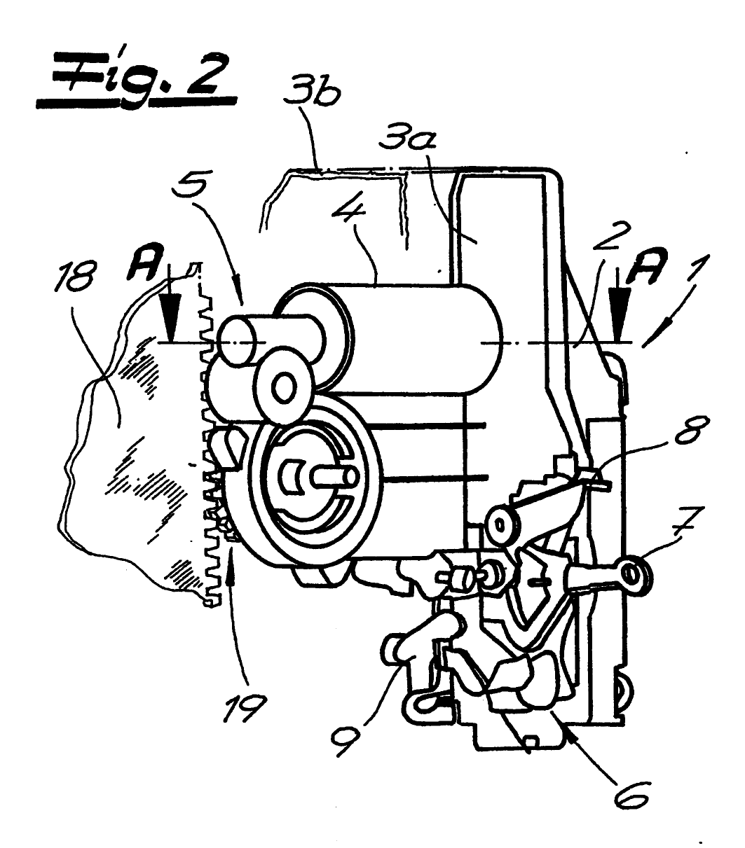

The design of the vehicle door latch 1 corresponds mainly to that of the vehicle door latch described in DE 297 23 462 U1. FIG. 2 shows a locking mechanism 6 comprising a rotary catch and pawl, a locking lever or central locking lever 7 and two operating levers 8,9 for internal and external operation.

The housing 2, 3 of the door latch 1 comprises—as already described—a latch case 2 and cover 3 or the latch housing 3a and the latch cover 3b. The additional assembly 4 in form of a window lifting motor 4 is arranged on the external surface of the latch cover 3b of housing 2, 3. For this purpose, the latch cover 3b contains a seat 10, in which the additional assembly or the window lifting motor 4 is placed and fixed by bolting, riveting, clipping, etc. (see FIG. 5).

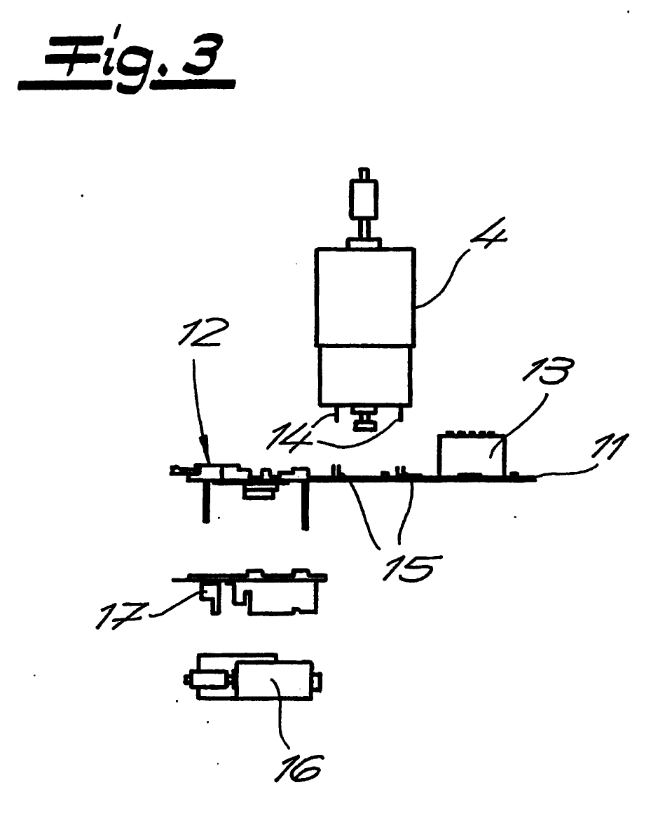

FIG. 3 shows that additional assembly 4 and door latch 1 are connected to a corresponding control board 11 and that a common control unit 12 is provided for the activation of the vehicle door latch 1 and the additional assembly 4. Said control unit is connected to a central control unit inside the vehicle via a socket 13 and a connection line plugged into said socket. It is apparent from the figure that the additional assembly 4 contains connection ridges 14 accommodated in receiving sockets 15 on the control board 11 to form an electrical connection with said board. An additional drive motor 16 for the vehicle door latch 1 is secured to the control board 11 with the aid of a fixing device 17.

Additional assembly 4 and drive motor 16 are arranged on different sides of the control board 11. In the context of the embodiment, the additional assembly 4 and the window lifting motor 4 are able not only to lift and lower the window pane 18 indicated in FIG. 4 but to also facilitate electrical opening of the vehicle door latch 1 in such a way that the pawl of the locking mechanism 6 is—if desired—lifted in the way described in principle in DE 196 50 826 A1.

Naturally, the window lifting motor or the additional assembly 4 is also able to carry out other latch functions. This may include the engaging of the rotary catch of the locking mechanism 6, as described in DE 199 42 360 A1. Also the movement of the locking lever 7, as part of a central locking function, is feasible.

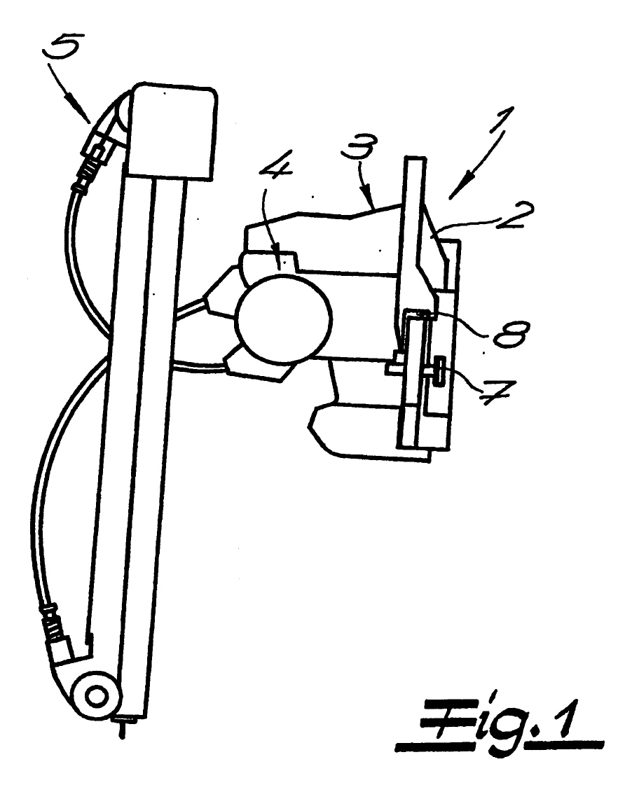

The window lifting mechanism 5 and/or the movement of the window pane 18 is designed in such a way that it includes integrated toothing on one or both sides in which the additional assembly 4 engages directly via an intermediate gear 19 (see FIG. 2). The toothing can either be directly integrated in the pane material or in a coating or profile connected to the windowpane 18. In this respect, reference is made to DE 197 03 720 A1 and DE 199 09 088 A1. In principle, the windowpane can also be displaced with the aid of Bowden cables as shown in the embodiment types of FIG. 1 and FIG. 4.

What is claimed is:

1. A vehicle door comprising
a vehicle door latch (1),
a housing (2, 3) of said vehicle door latch (1), and
at least one additional assembly (4),
wherein said additional assembly (4) is connected to said housing (2, 3) of said vehicle door latch (1).

2. The vehicle door of claim 1, wherein said housing (2, 3) comprises
a latch case (2),
a latch housing (3a), and
a latch cover (3b),
said latch cover (3b) having an external surface and an internal surface.

3-9. (canceled)

10. The vehicle door of claim 2, wherein said latch housing (3a) and said latch cover (3b) consist of at least one part.

11. The vehicle door of claim 2, wherein said latch housing (3a) and said latch cover (3b) consist of at least two parts.

12. The vehicle door of claim 2, wherein said additional assembly (4) is arranged on said external surface of said latch cover (3b).

13. The vehicle door of claim 2, wherein said latch cover (3b) seals off said vehicle door latch (1) and serves as holder for at least one said additional assembly (4).

14. The vehicle door of claim 1, wherein said housing (2, 3) forms a seat (10) and said additional assembly (4) is secured in said seat (10) of said housing (2, 3).

15. The vehicle door of claim 1, wherein said latch housing (2, 3) and/or said latch cover are made of plastic.

16. The vehicle door of claim 15, wherein said plastic contains fiberglass.

17. The vehicle door of claim 15, wherein said plastic is polybutylenterphthalate.

18. The vehicle door of claim 16, wherein said plastic contains up to 30 volume percent of fiberglass.

19. The vehicle door of claim 1, wherein a common control unit (12) is provided for controlling said vehicle door latch (1) and said additional assembly (4).

20. The vehicle door of claim 1, wherein said additional assembly (4) and said door latch (1) are connected to a corresponding control board (11).

21. The vehicle door of claim 1, wherein said additional assembly (4) carries out one or more functions selected from the group consisting of lifting windows and adjusting mirrors.

22. The vehicle door of claim 21, wherein said additional assembly (4) further carries out one or more latch functions.

23. The vehicle door of claim 22, wherein said latch functions are selected from the group consisting of electric opening, closing, double locking/unlocking, engaging/disengaging child lock, and central locking.

24. The vehicle door of claim 23, wherein said latch functions are performed at the same time.

25. The vehicle door of claim 23, wherein said latch functions are performed at different times.

26. The vehicle door of claim 2, wherein said latch case (2) comprises an axial support (20) for said latch housing (3a).

27. The vehicle door of claim 2, wherein said latch cover (3b) contains at least one rib (21) for reinforcement.

28. The vehicle door of claim 1, wherein said housing (2, 3) serves as a connection to an external door handle.

29. The vehicle door of claim 1, wherein said additional assembly (4) is selected from the group consisting of a triggering mechanism for one or more side airbags, a loudspeaker arrangement, a height adjustment for the arm rest, a light for indicating an open vehicle door, a control unit for the door latch, and a mirror heating/adjusting device.

30. The vehicle door of claim 1, wherein said vehicle door latch (1) and a window lifting mechanism are combined into said additional assembly (4).
